(19) United States
(12) Patent Application Publication
(10) Pub. No.: US 2007/0269574 A1
(43) Pub. Date: Nov. 22, 2007

(54) Beverage Production System

(76) Inventor: Anatoly Anatolyevich Kutyev, Moscow (RU)

Correspondence Address: PATENTTM.US, P. O. BOX 82788, PORTLAND, OR, 97282-0788, US

(21) Appl. No.: 11/574,974

(22) PCT Filed: Sep. 5, 2005
(86) PCT No.: PCT/RU05/00450

§ 371 Date: Mar. 8, 2007

(30) Foreign Application Priority Data
Sep. 10, 2004 (RU) 2004127002

(51) Int. Cl. A23L 2/00

(52) U.S. Cl. 426/590

(57) ABSTRACT

The invention relates to the food industry, in particular to producing alcohol-free beverage comprises a liquid base and nitrogen oxide which is used in a quantity equal to or less than 40 g rer 1 litre of liquid base. The gas is introduced at a temperature ranging from 1 to 25° C. and a pressure of 1-21 atm according to the beverage production process. Said invention makes it possible to improve the final product guilty by preserving the beverage taste and flavour during a storage period.

The present invention relates to the food industry, in particular to production technologies for alcohol-free beverages exhibiting “laughing” properties.

A method of making a healing drinking water is known in the art that comprises making ice from source water by freezing water vapor being formed from source water at a temperature not more than 10° C., its subsequent melting and collection where in the process of ice melting it is influenced by ultraviolet or infrared radiation and obtained melt water is saturated with a gas or a gas mixture. It is recommended that carbon dioxide and/or its mixture with a noble gas, e.g., xenon, is used as a gas of this process (see, RU2010772 CI, C02F9/00, publ. Apr. 15, 1994).

A method of treating drinking mineral water and a beverage on its basis is also known that provides for aerating a liquid with a mixture comprising a noble gas, e.g., argon, its filling and sealing in containers, where the argon content of a gas mixture is maintained at a level at least 3% by volume and treatment is carried out until an equilibrium concentration of a gas in a liquid is obtained (see, RU 2218055 C2, A23L2/54, publ. Dec. 10, 2003).

A disadvantage of the above methods is their energy intensity and technological complexity of making beverages, and, as a consequence, high production costs.

The closest analogous solution is a beverage production method that provides for introducing nitrous oxide into a liquid base for which water is used (see, RU 92010834 A, publ. Mar. 27, 1995). A disadvantage of the said method is that it is used only for making a beverage used for maintaining good mood, i.e., for ensuring an “inebriate and laughing” effect.

The technical effect is quality improvement of the finished product owing to preservation of flavor and aroma of the beverage until its expiration date.

The said technical effect is achieved due to the said beverage production method provides for introducing nitrous oxide into a liquid base in an amount not more than 40 grams per 1 liter of a liquid base at a temperature ranging from 1° C. to 25° C. and a pressure ranging from 1 atm to 21 atm.

The said method may be characterized by that a mineral or drinking water, or a juice is used as a liquid base.

Further, the produced beverage may be additionally saturated with oxygen or carbon dioxide or their mixture, as well as sugar or a sweetener, vitamins, microelements and medicinal preparations may be also added. For the latter, a mixture of vitamins A, B₁, B₂, B₆, B₁₂, D, E, folic acid, calcium-O-pantothenate (vitamin B₃), nicotinic acid (vitamin PP), biotin, ascorbic acid or sodium ascorbinate may be used in the respective amounts (in grams): 2.0-8.0; 0.02-0.06; 30.0-40.0; 4.0-10.0; 4.0-8.0; 4.0-10.0; 0.01-0.03; 1.0-4.0; 25.0-35.0; 60.0-70.0; 0.5-1.0 and 300.0-400.0.

The present invention is intended to create a beverage lacking disadvantages peculiar to alcoholic beverages formed in the basis of ethyl alcohols. In addition to it, the inventive technology is production-efficient, environment-friendly, i.e., causes no harmful emissions to the atmosphere and does not require expensive equipment and power, as in the case of alcoholic beverage production. The produced beverage has special organoleptic properties, tasty and safe for the human vital organs (liver, stomach, vascular system, etc.). The technology is based on the task to create a beverage comprising a liquid base with nitrous oxide dissolved therein, causing an inebriate and laughing effect for consumers.

As to its nature, nitrous oxide is a colorless has having a slight pleasant odor and sweetish taste; it is heavier than air (its relative density is 1.527), soluble in water in proportion of 1:2. It liquefies into a colorless liquid at 0° C. and pressure of 30 atm.

The inventive method may be implemented as follows.

The liquid base is prepared according to a standard technology. A mineral or drinking water or a juice may be used as a liquid base. If for preparation of a liquid base drinking water is used, it is purified, clarified, disinfected and cleaned from iron. Disinfection is carried out by passing though filters, chlorinating, treating with ozone, treating with silver ions, treating with bactericidal radiation or ultrasonic waves, and water is softened to the required salt content. If fruit juices are used as the liquid base (orange, lemon, apple, grapefruit, mango, etc. or a mixture thereof), they are fed to a blending tank after filtration. If juice concentrates are used, before filtration they are reduced to the initial juice concentration. Then, nitrous oxide is introduced into the liquid base in an amount not more than 40 grams per 1 liter of the liquid base at a temperature ranging from 1° C. to 25° C. [symbol] C and a pressure ranging from 1 atm to 21 atm.

Before introducing nitrous oxide, sugar may be added to the liquid base in the form of a sugar syrup or a sweetener for which aspartame, stevioside, sweetly, riosan, etc. may be used. Also vitamins may be added, such as vitamin B or C, and then, while stirring the obtained solution, microelements, such as iron, calcium, magnesium, etc., are introduced successively. The liquid base is additionally supplemented with medicinal preparations in the form of a mixture of vitamins A, B₁, B₂, B₆, B₁₂, D, E, folic acid, calcium-O-pantothenate (vitamin B₃), nicotinic acid (vitamin PP), biotin, ascorbic acid or sodium ascorbinate in the respective amounts (in grams): 2.0-8.0; 0.02-0.06; 30.0-40.0; 4.0-10.0; 4.0-8.0; 4.0-10.0; 0.01-0.03; 1.0-4.0; 25.0-35.0; 60.0-70.0; 0.5-1.0 and 300.0-400.0.

The obtained blend is thoroughly mixed for 10-14 minutes, aged, filtered, and its volume is brought to a preset value by adding the liquid base. The obtained beverage may be saturated with carbon dioxide or oxygen or their mixture, and then it is fed to filling equipment.

### EXAMPLE 1

of producing a beverage by the inventive method. The beverage is made as above, except for the following components are taken per 1 liter of a liquid base:

| | |
|---|---|
| Nitrous oxide, g | 5 |
| Liquid base | the rest. |

### EXAMPLE 2

The beverage is made as in Example 1, with the following component content:

| | |
|---|---|
| Nitrous oxide, g | 4 |
| Vitamin B₁₂, mg | 5 |
| Mineral water, medium salt load | the rest. |

### EXAMPLE 3

The beverage is made as in Example 1, with the following component content:

| | |
|---|---|
| Nitrous oxide, g | 8 |
| Vitamin C, mg | 150 |
| Iron, mg | 1.1 |
| Drinking water | the rest. |

### EXAMPLE 4

The beverage is made as in Example 1, with the following component content:

| | |
|---|---|
| Nitrous oxide, g | 7 |
| Medicinal preparation, g | 430.53 |
| Zinc, mg | 0.5 |
| Orange juice | the rest |

Where the said medicinal preparation is a mixture comprising Vitamin A—2.0 g; Vitamin B₁—0.02 g; Vitamin B₂—30.0 g; Vitamin B₆—4.0 g; Vitamin B₁₂—4.0 g; Vitamin D—4.0 g; Vitamin E—0.01 g; folic acid—1.0 g; calcium-D-pantothenate (Vitamin B₃)—25.0 g; nicotinic acid (Vitamin PP)—60.0 g; biotin—0.5 g; and ascorbic acid or sodium ascorbinate—300 g.

### EXAMPLE 5

The beverage is made as in Example 1, with the following component content:

| | |
|---|---|
| Nitrous oxide, g | 7 |
| Medicinal preparation, g | 586.09 |
| Zinc, mg | 0.5 |
| Orange juice | the rest |

Where the said medicinal preparation is a mixture comprising Vitamin A—8.0 g; Vitamin B₁—0.06 g; Vitamin B₂—40.0 g; Vitamin B₆—10.0 g; Vitamin B₁₂—8.0 g; Vitamin D—10 g; Vitamin E—0.03 g; folic acid—4.0 g; calcium-D-pantothenate (Vitamin B₃)—35.5 g; nicotinic acid (Vitamin PP)—70.0 g; biotin—1.0 g; and ascorbic acid or sodium ascorbinate—400 g.

The inventive method of producing a beverage ensures maintaining the beverage flavor and aromatic properties for a long time. The storage period is 1-1.5 years as compared to the prototype. The inventive method of producing a beverage is safe for the environment, since it causes no harmful emissions to the atmosphere, and it does not require expensive equipment and power.

What is claimed, is:

1. A beverage production method providing for introducing nitrous oxide into a liquid base in an amount not more than 40 grams per 1 liter of a liquid base at a temperature ranging from 1° C. to 25° C. and a pressure ranging from 1 atm to 21 atm.

2. A method according to claim 1, wherein mineral or drinking water, or a juice is taken as a liquid base.

3. A method according to claim 1, wherein the beverage is additionally saturated with oxygen or carbon dioxide or their mixture.

4. A method according to claim 1, wherein sugar or a sweetener is additionally introduced into the beverage.

5. A method according to claim 1, wherein vitamins or microelements are additionally introduced into the beverage.

6. A method according to claim 1, wherein the beverage is supplemented with a mixture of vitamins A, B₁, B₂, B₆, B₁₂, D, E, folic acid, calcium-O-pantothenate (vitamin B₃), nicotinic acid (vitamin PP), biotin, ascorbic acid or sodium ascorbinate in the respective amounts (in grams): 2.0-8.0; 0.02-0.06; 30.0-40.0; 4.0-10.0; 4.0-8.0; 4.0-10.0; 0.01-0.03; 1.0-4.0; 25.0-35.0; 60.0-70.0; 0.5-1.0 and 300.0-400.0.
